(19) United States
(12) Patent Application Publication
(10) Pub. No.: US 2012/0058568 A1
(43) Pub. Date: Mar. 8, 2012

(54) LIQUID CHROMATOGRAPH AND ANALYSIS METHOD

(75) Inventors: Midori Sasaki, Hitachinaka (JP); Masako Ishikawa, Hitachiota (JP); Hiroaki Nakagawa, Hitachinaka (JP); Hiroshi Suzuki, Hitachinaka (JP); Masahito Ito, Hitachinaka (JP)

(73) Assignee: Hitachi High-Technologies Corporation, Tokyo (JP)

(21) Appl. No.: 13/202,710

(22) PCT Filed: Mar. 3, 2010
(86) PCT No.: PCT/JP2010/001453

§ 371 Date: Aug. 22, 2011

(30) Foreign Application Priority Data
Mar. 4, 2009 (JP) 2009-050074
Nov. 19, 2009 (JP) JP2009/006210

(51) Int. Cl. G01N 30/02; G01N 21/64

(52) U.S. Cl. 436/161; 422/82.08

(57) ABSTRACT

It is an object of the present invention to provide a liquid chromatograph which, in a high performance liquid chromatograph analysis using a post-column method, can maintain mixing precision of a sample eluted from a column and a reaction reagent without a special mixing and reacting portion, prevent diffusion of a target component, and perform measurement with high sensitivity.

The liquid chromatograph of the present invention has a mobile phase feed pump 1 with an allowable pressure higher than 40 MPa, a separation column 3 having a packing material with a particle diameter of 3 μm or smaller, and a reaction reagent feed pump 8 to which a pressurizing coil 9 for increasing the pressure acting on the reaction reagent feed pump 8 is connected.

### TECHNICAL FIELD

The present invention relates to a liquid chromatograph and an analysis method using a post-column method.

### BACKGROUND ART

A liquid chromatograph using a post-column method is an analysis method performed by mixing one or more reaction reagents into a sample eluted from a separation column, and detecting the resulting reaction product. It is widely used for measurement requiring high selectivity and measurement of substances with no UV absorption.

FIG. 7 is a structural diagram of a known high performance liquid chromatograph using a post-column method. The high performance liquid chromatograph comprises a mobile phase feed pump 1, an injector 2 for injecting a sample, a separation column 3 for separating the sample, a column oven 4 for maintaining the separation column 3 at a constant temperature, a T-joint 5 having a three-way joint structure for mixing the sample eluted from the separation column 3 and a reaction reagent, a pipe 6 through which the sample eluted from the separation column 3 and the reaction reagent flow while being mixed together, a detector 7 for detecting a target component in the sample, and a reaction reagent feed pump 8 for feeding the reaction reagent. The sample is injected from the injector 2, and passes through the separation column 3 by a mobile phase fed from the mobile phase feed pump 1 to be separated. The separated sample is mixed with the reaction reagent fed from the reaction reagent feed pump 8 at the T-joint 5 to be allowed to react. The sample then passes through the pipe 6 and is detected by the detector 7.

In a liquid chromatograph, separation power is improved by reducing the particle size of a packing material in the separation column 3 to about 2 μm. Therefore, the separation power can be maintained and analysis time can be shortened by increasing the linear flow velocity of the mobile phase and reducing the size of the separation column 3 accordingly, but the pressure acting on the pump is increased. Conventionally, it has been anticipated that a particle diameter of a column packing material was 3 to 5 μm, and liquid chromatograph devices having pumps with allowable pressures of about 40 MPa have been widely spread. Since 2004, however, manufacturers have been developing a series of liquid chromatograph devices having pumps with allowable pressures higher than 40 MPa (hereinafter referred to as “ultra performance chromatograph”) in anticipation of a particle diameter of a column packing material smaller than 3 μm. Commercially available columns for ultra performance chromatography include LaChromUltra C18 manufactured by Hitachi High-Technologies Corporation (particle diameter of packing material: 2 μm), ZORBAX SB-C18 manufactured by Agilent Technologies Inc. (particle diameter of packing material: 1.8 μm), Ascentis RP-Amide manufactured by Sigma-Aldrich Inc. (particle diameter of packing material: 2.7 μm). The maximum allowable pressure of the first one is 50 MPa, while the same of the last two is 60 MPa. When the devices such as pumps and columns are usually used, they are often used at a pressure half the maximum allowable pressure or lower. Presently, liquid chromatographs are categorized into two groups: high performance liquid chromatographs with the allowable pressure of 40 MPa or lower; and ultra performance liquid chromatographs with the allowable pressure higher than 40 MPa.

Heretofore, no analysis conducted by a post-column method using an ultra performance liquid chromatograph as stated above has been published. This is presumably because of the following problems:

When a passage including the pipe 6 running from the T-joint 5 to the detector 7 in which a sample eluted from the separation column 3 shown in FIG. 7 and a reaction reagent are mixed is referred to as a reagent mixing and reacting part, the mixing and reaction are sufficiently carried out by increasing the internal capacity of this reagent mixing and reacting part, but diffusion of the target component occurs and the detected peak of the target component of the chromatogram is broadened. This lowers separation performance and sensitivity.

On the other hand, if the internal capacity of the reagent mixing and reacting part is reduced, the mixing and reaction are not sufficiently carried out, and baseline noise of the chromatogram is increased and sensitivity is lowered.

In particular, when the mixing and reaction are carried out at a low flow rate of, for example, 0.5 mL/min or lower, the influence of the above-mentioned problems is large. In the inventions described in patent documents 1, 2 and 3, reagent mixing and reacting parts having special structures for increasing the mixing efficiently are suggested.

### PRIOR ART DOCUMENTS

### Patent Documents

Patent document 1: Japanese Unexamined Patent Publication No. 2002-131326
Patent document 2: Japanese Unexamined Patent Publication No. 2005-69818
Patent document 3: Japanese Unexamined Patent Publication No. H8-304373

### SUMMARY OF THE INVENTION

### Problems to be Solved by the Invention

An object of the present invention is to provide an ultra performance liquid chromatograph and its method usable for a post-column method, which eliminates the necessity for a reagent mixing and reacting part having a special structure, prevents the detected peak of a chromatogram from being broad, and prevents lowered sensitivity.

### Means for Achieving the Objects

In order to achieve the above object, in an embodiment of the present invention, a liquid chromatograph comprises a mobile phase feeding portion which feeds a mobile phase, an injector which injects a sample into the mobile phase, a separation column which separates the sample, a reaction reagent feeding portion which feeds the reaction reagent to the mobile phase after being passed through the separation column, a joint portion in which the mobile phase after being passed through the separation column and the reaction reagent are mixed, a pipe in which the sample is allowed to react with the reaction reagent and passes through, and a detector which detects the sample which has been allowed to react with the reaction reagent, in which a pressurizing means is provided upstream of the detector so as to increase the pressure of the reaction reagent fed from the reaction reagent feeding portion to the pressure of the mobile phase. Herein, the term upstream means the side of the mobile phase and the mobile phase feed pump, while the term downstream means the detector side.

### Effect of the Invention

According to the present invention, a liquid chromatograph and a liquid chromatograph analysis method which can be used for a post-column method and can prevent the detected peak of a chromatogram from being broad and prevent a decrease in sensitivity can be provided.

### BRIEF DESCRIPTION OF THE DRAWINGS

FIG. 1 is a structural diagram which shows a main constitution of a liquid chromatograph, which is a first Example of the present invention.

FIG. 2 is a chromatogram obtained by a convention liquid chromatograph.

FIG. 3 is a chromatogram obtained by the liquid chromatograph according to the present invention.

FIG. 4 is a baseline chromatogram when the pressure applied on the reaction reagent feed pump is varied.

FIG. 5 is a baseline chromatogram when internal volume of the T-joint is varied.

FIG. 6 is a chromatogram of analysis of an organic acid where a post-column method is applied.

FIG. 7 is a structural diagram which shows a main constitution of a liquid chromatograph for performing a known post-column method.

FIG. 8 is a structural diagram which shows a main constitution of a second Example of the present invention, which is a liquid chromatograph for performing a post-column method.

FIG. 9 is a chromatogram for determining a relative fluorescence intensity for a relatively long period of time by using the ultra performance liquid chromatograph shown in FIG. 8.

FIG. 10 is a chromatogram which shows a difference in the detected peaks resulting from differences in the inner diameters of the pipe.

### MODE FOR CARRYING OUT THE INVENTION

Examples of the present invention will be described below with reference to drawings.

### Examples

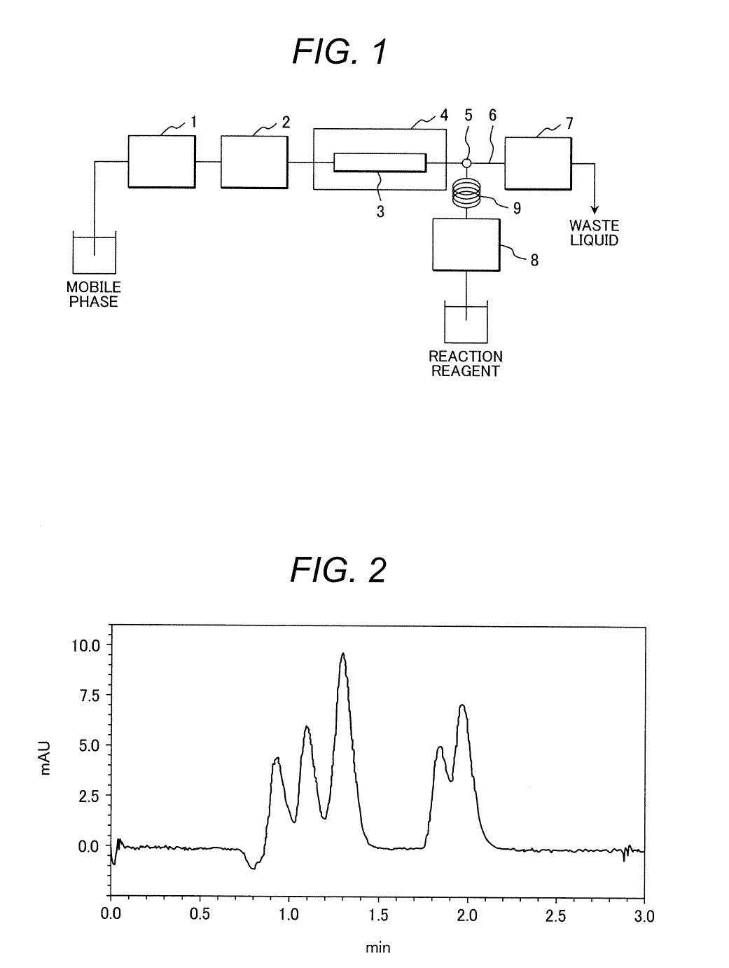

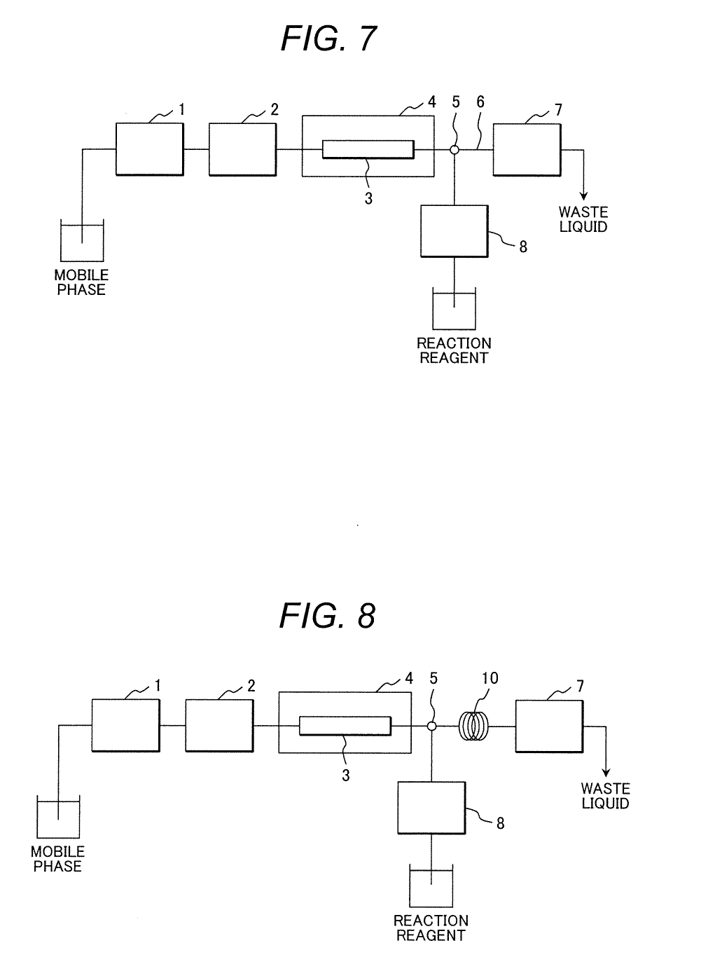

FIG. 1 is a structural diagram which shows a main constitution of a liquid chromatograph of a first Example of the present invention. The reference numerals in FIG. 1 are similar to those shown in FIG. 7, except that a pressurizing portion, that is, a pressurizing coil 9 is provided between the reagent mixing and reacting part constituted by the T-joint 5 and pipe 6 and the reaction reagent feed pump 8. The pressurizing portion is a pipe through which the reaction reagent can circulate.

The liquid chromatograph of this Example is an ultra performance liquid chromatograph using a post-column method, which has an allowable pressure of the mobile phase feed pump 1 higher than 40 MPa, and a particle diameter of the packing material of the separation column 3 smaller than 3 μm, for example, 2 μm. That is, realizing a post-column method in an ultra performance liquid chromatograph is suggested.

Therefore, in this Example, the capacity of the T-joint 5 is 1 μL or less. The pressurizing coil 9 for increasing the pressure acting on the reaction reagent feed pump 8 is connected between the T-joint 5 and the reaction reagent feed pump 8. The pressurizing coil 9 is extended in its length to increase the internal resistance of the pipe, and is made compact in the form of a coil so that it can be accommodated in the device. Accordingly, feeding pulsation of the reaction reagent feed pump 8 can be suppressed and stabilized, and detection sensitivity can be increased.

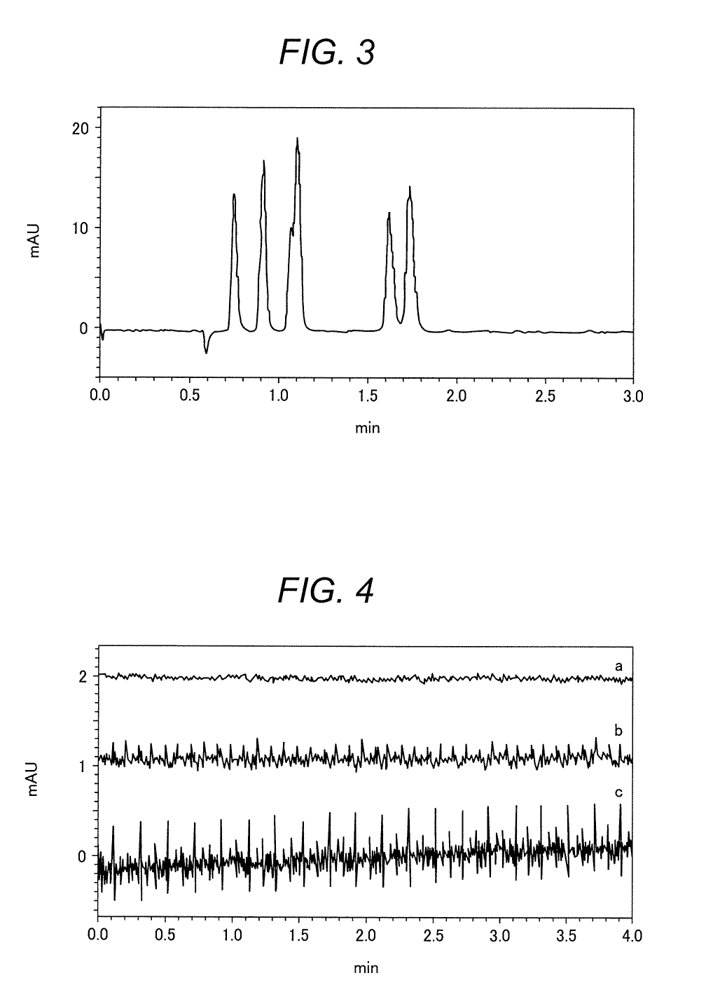

FIGS. 2 and 3 are chromatograms obtained by a liquid chromatograph: FIG. 2 is a chromatogram obtained by a known method as Comparative Example, while FIG. 3 is a chromatogram obtained by the method of this Example. The analysis conditions when these chromatograms were obtained are shown below.

Mobile phase: 3 mM perchloric acid solution

Mobile phase flow rate: 0.4 mL/min
Column temperature: 25° C.
Injection volume: 1 μL
Reaction reagent: Bromothymol Blue (BTB) solution
Reaction reagent flow rate: 0.5 mL/min
Detector: Visible light detector (detectable wavelength: 440 nm)

When the known liquid chromatograph shown in FIG. 7 was used, the pressure acting on the reaction reagent feed pump 8 which feeds the reaction reagent was 3 MPa or lower; the T-joint 5 used in which the sample eluted from the separation column 3 and the reaction reagent are mixed has an internal volume of 2.1 μL; the pipe 6 used had an inner diameter of 0.25 mm used by a known post-column method; and measurement was performed under the above analysis conditions, giving a chromatogram shown in FIG. 2.

When the known reagent mixing and reacting part constituted by the T-joint 5 and the pipe 6 shown in FIG. 7 is used, as shown in FIG. 2, the detected peak of the target component in the chromatogram becomes broader at the foot, and the degree of separation is lowered. This is presumably because the large internal volume capacity of the reagent mixing and reacting part causes diffusion of the target component.

In the liquid chromatograph according to the present invention shown in FIG. 1, on the other hand, the allowable pressure of the entire system including the separation column 3 and the pipe is made higher than 40 MPa, and the pressurizing coil 9 is connected so that the pressure acting on the reaction reagent feeding portion which feeds the reaction reagent, that is, the reaction reagent feed pump 8, is similar to the pressure acting on the mobile phase feed pump 1 which feeds the mobile phase. Accordingly, the feeding pulsation of the reaction reagent feed pump 8 can be suppressed and stabilized. The joint portion in which the sample eluted in the separation column 3 and the reaction reagent are mixed, that is, the T-joint 5 used here has an internal volume of 0.57 μL. The pipe 6 which connects the T-joint 5 and the detector 7 is a directly connected inlet tube of the detector having an inner diameter of 0.1 mm, which is smaller than 0.13 mm, in order to minimize its internal volume. The detector 7 is desirably such that has a low-capacity flow cell, and is capable of collecting data at a collection interval of detection of 200 ms or lower, and a response speed of 50 ms or lower.

In the chromatogram shown in FIG. 3, compared to that shown in FIG. 2, the rise of the detected peak of the target component is sharp. The broadening of the peak could be thus suppressed and the degree of separation could be improved. As described above, by using a T-joint having an internal volume of 1 μL and a pipe having an inner diameter of 0.13 mm or smaller for the liquid chromatograph of the post-column method according to this Example, the detected peak in the chromatogram can be prevented from being broad, and lowered sensitivity can be prevented.

FIG. 4 is a baseline chromatogram when the pressure applied to the reaction reagent feed pump 8 is varied. The baseline was measured with the pressure applied to the reaction reagent feed pump 8 being 34 MPa in case a; 9.4 MPa in case b; and 0 MPa in case c. Comparing the above three cases, case a, where the pressure is higher, has less noise. This indicates that the closer the pressure applied to the reaction reagent feed pump 8 to that of the mobile phase feed pump 1, the more the noise can be reduced. By providing the pressurizing coil 9 downstream of the reaction reagent feed pump 8 as shown in FIG. 1, the pressure applied on the reaction reagent feed pump 8 can be increased. A pipe having an inner diameter of 0.13 mm or smaller is desirably used as the pressurizing coil 9. Alternatively, when the inner diameter is 0.13 mm or larger, by increasing the length of the pressurizing coil 9, the pressure applied to the reaction reagent feed pump 8 can be increased.

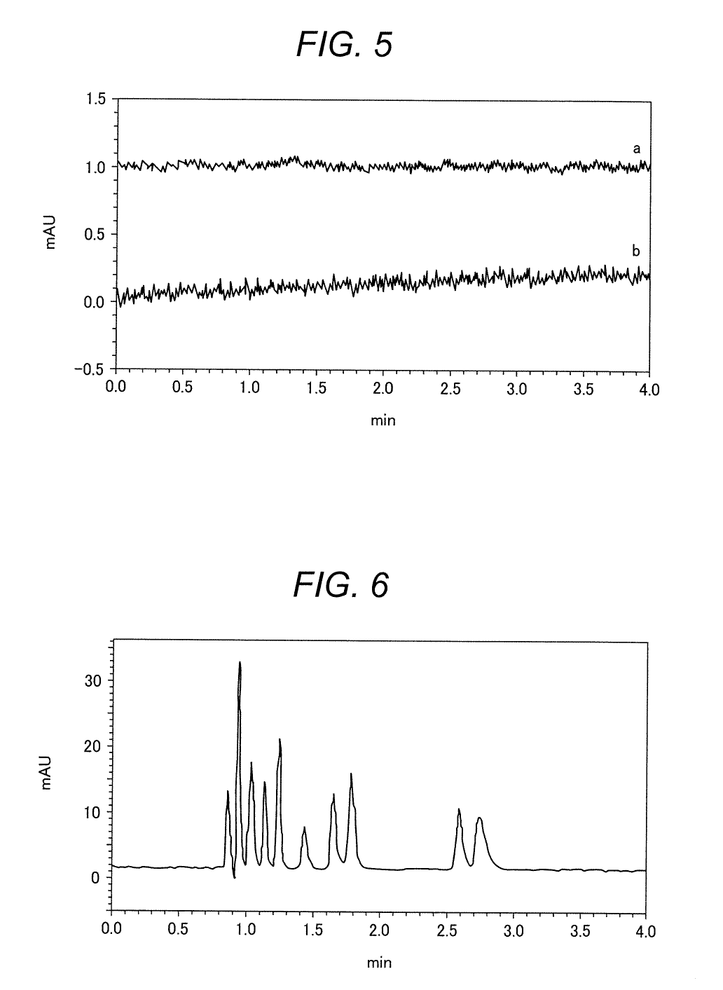

FIG. 5 is a baseline chromatogram when the internal volume of the T-joint 5 is varied. Since the size of the internal volume of the T-joint 5 in which the sample eluted from the separation column 3 and the reaction reagent are mixed together affects the mixing efficiency, the internal volume of the T-joint 5 is desirably 1 μL or lower. In FIG. 5, measurement was performed using the T-joint 5 having an internal volume of 0.57 μL in case a, and 2.06 μL in case b. A reduction in the baseline noise is higher incase a, indicating that the lower the internal volume of the T-joint 5, the higher the uniformity of mixing of the sample eluted from the separation column 3 and the reaction solution.

FIG. 6 is a chromatogram of analysis of an organic acid where a BTB post-column method is applied using the ultra performance liquid chromatograph according to the present invention shown in FIG. 1, and a Bromothymol Blue (BTB) solution as a reaction reagent. As shown in FIG. 6, the broadening of the detected peak is suppressed, showing that diffusion of the target component in the reagent mixing and reacting part can be suppressed and the target component can be determined.

For analysis of an organic acid using the BTB post-column method, a separation column using a packing material with ion exclusion mode and ion exchange mode is generally used. For separation of an organic acid, separation using reversed phase mode is also possible. However, the proportion of the water-based mobile phase is increased to enhance the retention to the separation column, and therefore it is undesirable in a column of normal reversed phase mode from the standpoint of stability. However, by using a separation column of reversed phase mode which is also hydrophilic as it has both functional groups of a hydrophilic amide group and reversed phase C18 (octadecyl), high separation performance can be stably obtained only with the water-based mobile phase. Therefore, in this Example shown in FIG. 6, a separation column of reversed phase mode which also has hydrophilicity is used, and a method which allows a Bromothymol Blue solution reaction by the BTB post-column method is used. This analysis is performed by using a small-sized separation column having a column packing material with a particle diameter of 2 μm and an ultra high performance liquid chromatograph having the mobile phase feed pump 1 with an allowable pressure higher than 40 MPa. Therefore, the linear flow velocity of the mobile phase is increased. In a separation column using a packing material of a known ion exclusion mode and ion exchange mode without lowering separation performance, compared to an analysis of an organic acid using the BTB post-column method, the measurement time can be reduced to about one tenth of a conventional method. Moreover, the amounts of the mobile phase and reagent used are reduced, thereby saving costs for them.

FIG. 8 shows another structural diagram of the second Example of the present invention, which is a high performance liquid chromatograph using a post-column method. The high performance liquid chromatograph comprises a mobile phase feed pump 1, an injector 2 for injecting a sample, a separation column 3 for separating the sample, a column oven 4 for maintaining the separation column 3 at a constant temperature, a T-joint 5 having a three-way joint structure for mixing the sample eluted from the separation column 3 and a reaction reagent, a pipe 6 through which the sample eluted from the separation column 3 and the reaction reagent flow while being mixed together, a detector 7 for detecting a target component in the sample, and a reaction reagent feed pump 8 for feeding the reaction reagent. The sample is injected from the injector 2, passes through the separation column 3 by a mobile phase fed from the mobile phase feed pump 1 to be separated. The separated sample is mixed with the reaction reagent fed from the reaction reagent feed pump 8 at the T-joint 5, and passes through the pipe 10 while being allowed to react therein and is detected by the detector 7.

In FIG. 8, the internal volume of the T-joint 5 used is 0.57 μL, which is smaller than 1 μL, as the first Example. As the pipe which connects the T-joint 5 and the detector 7, the pipe 10 having an inner diameter of 0.1 mm and a length of 1 m is used in addition to the pipe 6 used in the first Example. Since it has a length of 1 m, when it is accommodated in the device, it is made compact, for example, in the form of a coil as shown in FIG. 8. Increasing the length of the pipe 10 can increase the feed pressure from the reaction reagent feed pump 8.

This pipe has a pressurizing function as the pressurizing coil 9 in Example 1, and the length of the pipe 10 is preferably such that is required to provide the T-joint 5 with a pressure similar to that applied to the mobile phase feed pump 1, for example, about 0.8 m or longer. Moreover, the length of the pipe is set so that the pressure at the T-joint is not too high.

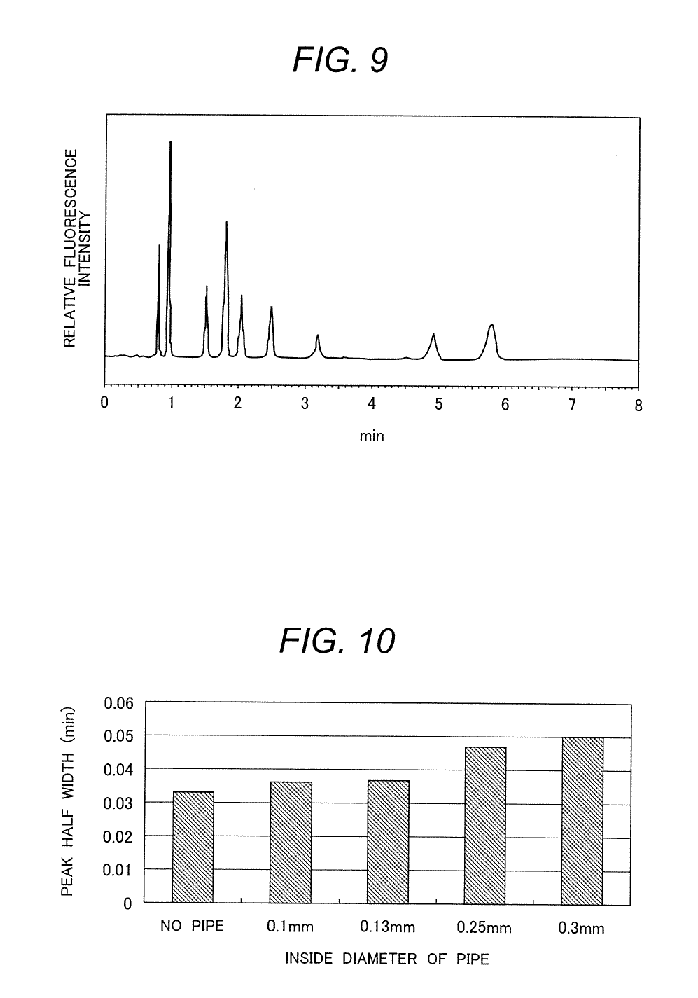

FIG. 9 is a chromatogram for determining a relative fluorescence intensity for a relatively long period of time by using the ultra performance liquid chromatograph shown in FIG. 8, and shows an example of chromatograms in which an orthophthalaldehyde (OPA) solution is used as a reaction reagent, and an OPA post-column method is employed for analysis of a compound having an amino group such as amino acids. The vertical axis represents relative fluorescence intensity, while the horizontal axis represents elution time.

The analysis conditions when the chromatogram shown in FIG. 9 is obtained are shown below.

Separation column: Inner diameter: 2.1 mm, length: 100 mm
Column packing material: Particle diameter: 2 μm, silica ODS (chemically bonded porous spherical silica gel packing material whose surface is modified with octadecylsilyl group)
Mobile phase: 20 mmol/L phosphoric acid buffer solution, Sodium hexanesulfonate/acetonitrile=92/8 (molar ratio)
Mobile phase flow rate: 0.4 mL/min
Column temperature: 25° C.
Injection volume: 1 μL
Reaction reagent: Orthophthalaldehyde (OPA) solution
Reaction reagent flow rate: 0.4 mL/min
Detector: Fluorescence detector (excitation wavelength: 345 nm, fluorescence wavelength: 450 nm)
As mentioned above, by employing the constitution of the present invention using a low-capacity joint and a pipe having an inner diameter of 0.13 mm or smaller, the broadening of the detected peak of the target component in the chromatogram can be also suppressed in the OPA post-column method.

Herein, the broadness of the detected peak of the target component in the separation column will be determined by using a known calculating equation, and the effects of the present invention will be verified. Referring to the document “High Performance Liquid Chromatography Handbook” edited by The Japan Society For Analytical Chemistry, Kanto Branch, published by Maruzen Co., Ltd. (March, 2000), when the broadness of the detected peak of the target component in the separation column is dispersion σc, σc can be represented by the following equation:

σc=0.6πdc²hdp(N)^{1/2}(1+k)/4 Equation 1

wherein dc is a diameter of the separation column; h is a height equivalent to a theoretical plate; dp is a particle diameter of packing material; N is a theoretical plate number; and k is a retention coefficient. When dc=2 mm, h=4, dp=2 μm, N=10000, and k=0, σc is 1.5 μL.

When the broadness outside the separation column is dispersion σex, and the standard deviation of this is a, the relationship between σex and a is represented by the following equation:

((1+a)σc)²=σc²+σex² Equation 2

If the broadness of the detected peak of the target component is allowed up to 20% and a=0.2, σex=1 μL. Furthermore, the pipe which connects the reagent mixing and reacting part and the detector is provided, and the inner diameter of this pipe is 0.13 mm or smaller. According to the description in Japanese Unexamined Patent Publication No. 2002-243715, the spreading (σp) of the sample in the pipe is represented by the following equation:

σp²=r⁴vLp/24Dm Equation 3

where r is the radius of the inner diameter of the pipe; v is a flow velocity; Lp is the length of the pipe; and Dm is the diffusion coefficient of a solute. When v=1.2 mL/min, Lp=100 cm,

and Dm=1.2×10⁻⁹ (m²/s), comparison using pipes having inner diameters of 0.25 mm and 0.13 mm which are commonly sold for high performance liquid chromatographs reveals that the spreading is 0.53 μL with the pipe having the inner diameter of 0.25 mm, while it is 0.04 μL with the pipe having the inner diameter of 0.13 mm. The detected peak has already been broadened at the connection portion, and the broadness is also increased as at the connection portion by using the pipe having the inner diameter of 0.25 mm. However, the influence is reduced by one digit than at the connection portion by using the pipe having the inner diameter of 0.13 mm or smaller, and the broadness is virtually neglectable. Any of these constitutions or a combination of these can provide an ultra performance liquid chromatograph which can prevent the detected peak of the target component from being broad and prevent lowered sensitivity.

FIG. 10 is a chromatogram which shows a difference in the detected peaks caused by a difference in the inner diameters of the pipe. Four kinds of commercially available pipe products were used for analysis. The pipes had a constant length of 1 m but had inner diameters of 0.1 mm, 0.13 mm, 0.25 mm and 0.3 mm, respectively. In addition, for the purpose of comparison, the T-joint 5, reaction reagent feed pump 8 and pipe 10 in FIG. 10 were removed, and the column 3 and detector 7 were connected with a pipe having an inner diameter of 0.1 mm, which is smaller than 0.13 mm over the shortest distance. An analysis performed in such a case revealed a peak half width of 0.033 minutes. The vertical axis in FIG. 10 represents a half value width (unit: minute) of the detected peak of the chromatogram. The peak half widths when the inner diameters of the pipe 10 are 0.1 mm and 0.13 mm are 0.036 minutes and 0.037 minutes, respectively, which are greatly lower than the values 0.047 minutes and 0.050 minutes when the inner diameters are 0.25 mm and 0.3 mm. The spreading of the sample in the pipe is, as shown by Equation 3 above, proportionate to the square of the inner diameter of the pipe. Herein, when spreading in a pipe having an inner diameter of 0.1 mm is 1, the spreading in pipes having inner diameters of 0.13 mm, 0.25 mm and 0.3 mm are 1.7, 6.3 and 9.0, respectively, matching the data in the present invention. The peak half widths when the inner diameters of the pipe 10 are 0.1 mm and 0.13 mm, respectively, are values close to that in the case of the example shown in FIG. 1. This shows that if the inner diameter of the pipe 10 is 0.13 mm or smaller, the broadening of the detected peak in a chromatogram can be suppressed and prevented.

### INDUSTRIAL APPLICABILITY

The present invention can be applied to a liquid chromatograph usable for a post-column method in which a detected peak in a chromatogram can be prevented from being broad and lowered sensitivity can be prevented.

### EXPLANATION OF REFERENCES

1 Mobile phase feed pump
2 Injector
3 Separation column
4 Column oven
5 T-joint
6 Pipe
7 Detector
8 Reaction reagent feed pump
9 Pressurizing coil
10 Pipe

1. A liquid chromatograph comprising:
a separation column,
a mobile phase feeding portion which feeds a mobile phase to the separation column,
a reaction reagent feeding portion which feeds the reaction reagent to a liquid after being passed through the separation column,
a joint portion in which the liquid after being passed through the separation column and a reaction reagent are mixed, and
a detecting portion which detects a component in the sample in the joint portion, the liquid chrmoatograph being such that:
an allowable pressure of the mobile phase feeding portion is higher than 40 MPa, a particle diameter of a packing material in the separation column is smaller than 3 μm,
a pressurizing portion for increasing a pressure acting on the reaction reagent feeding portion is connected between the reaction reagent feeding portion and the joint portion,
and a capacity of the joint portion is 1 μL or lower.

2. A liquid chromatograph comprising:
a separation column,
a mobile phase feeding portion which feeds a mobile phase to a separation column,
a reaction reagent feeding portion which feeds the reaction reagent to a liquid after being passed through the separation column,
a joint portion in which a liquid after being passed through the separation column and the reaction reagent are mixed, and
a detecting portion which detects a component in the sample in the joint portion, the liquid chromatograph being such that:
an allowable pressure of the mobile phase feeding portion is higher than 40 MPa, a particle diameter of a packing material in the separation column is smaller than 3 μm,
a pressurizing portion for increasing a pressure acting on the reaction reagent feeding portion is connected between the reaction reagent feeding portion and the joint portion,
a connection pipe which connects the joint portion and the detecting portion is provided, and an inner diameter of the connection pipe is 0.13 mm or smaller.

3. The liquid chromatograph according to claim 1 or 2, wherein the pressurizing portion is in the form of a coil.

4. The liquid chromatograph according to any one of claims 1 to 3, wherein the pressurizing portion is a pipe having an inner diameter of 0.13 mm or smaller.

5. The liquid chromatograph according to any one of claims 1 to 4, wherein the pressurizing portion increases a pressure acting on the reaction reagent feeding portion to a level similar to that of a pressure acting on the mobile phase feeding portion.

6. The liquid chromatograph according to claim 1, wherein a connection pipe which connects the joint portion and the detecting portion is provided, and an inner diameter of the connection pipe is 0.13 mm or smaller.

7. The liquid chromatograph according to claim 2, wherein the capacity of the joint portion is 1 μL or lower.

8. The liquid chromatograph according to any one of claims 1 to 7, wherein a Bromothymol Blue solution is used as the reaction reagent.

9. The liquid chromatograph according to any one of claims 1 to 7, wherein an orthophthalaldehyde solution is used as the reaction reagent.

10. The liquid chromatograph according to any one of claims 1 to 9, wherein the separation column is a column of reversed phase mode having hydrophilicity.

11. (canceled)

12. A liquid chromatograph comprising:
a separation column which separates the sample,
a mobile phase feeding portion which feeds a mobile phase to the separation column,
an injector which injects a sample into the mobile phase,
a reaction reagent feeding portion which feeds a reaction reagent to the mobile phase after being passed through the separation column,
a joint portion in which the mobile phase after being passed through the separation column and the reaction reagent are mixed,
a pipe through which the sample passes while being allowed to react with the reaction reagent,
and a detector which detects the sample which has been allowed to react with the reaction reagent,
wherein a pressurizing coil which increases the pressure of the reaction reagent fed from the reaction reagent feeding portion to the pressure of the mobile phase is provided between the reaction reagent feeding portion and the joint portion.

13. A liquid chromatograph comprising:
a mobile phase feeding portion which feeds a mobile phase,
an injector which injects a sample into the mobile phase,
a separation column which separates the sample,
a feeding portion which feeds a reaction reagent to the mobile phase after being passed through the separation column,
a joint portion in which the mobile phase after being passed through the separation column and the reaction reagent are mixed,
a pipe through which the sample passes while being allowed to react with the reaction reagent,
and a detector which detects the sample which has been allowed to react with the reaction reagent, the liquid chromatograph being such that:
the length of the pipe between the joint portion and the detector is increased so that a pressure of the reaction reagent fed from the reaction reagent feeding portion is increased to the pressure of the mobile phase.

14. An analysis method using a liquid chromatograph comprising:
a mobile phase feeding portion which feeds a mobile phase,
a separation column,
a reaction reagent feeding portion which feeds the reaction reagent to a liquid after being passed through the separation column,
a joint portion in which a liquid eluted from the separation column and the reaction reagent are mixed,
and a detecting portion, the method being such that:
an allowable pressure of the mobile phase feeding portion is higher than 40 MPa, a particle diameter of a packing material in the separation column is smaller than 3 μm, and the capacity of the joint portion is 1 μL or lower to increase a pressure acting on the reaction reagent feeding portion.

15. An analysis method using a liquid chromatograph comprising:
a mobile phase feeding portion which feeds a mobile phase,
a separation column,
a reaction reagent feeding portion which feeds the reaction reagent to a liquid after being passed through the separation column,
a joint portion in which a liquid eluted from the separation column and the reaction reagent are mixed, and
a detecting portion, the method being such that:
an allowable pressure of the mobile phase feeding portion is higher than 40 MPa, a particle diameter of a packing material in the separation column is smaller than 3 μm, and an inner diameter of a connection pipe which connects the joint portion and the detecting portion is 0.13 mm or smaller to increase reaction a pressure acting on the reaction reagent feeding portion.

16. The analysis method according to claim 12, wherein a pressure acting on the reaction reagent feeding portion is increased to a level similar to that of a pressure acting on the mobile phase feeding portion.
